(19) United States
(12) Patent Application Publication
(10) Pub. No.: US 2018/0097953 A1
(43) Pub. Date: Apr. 5, 2018

(54) DOCUMENT TRANSPORT DEVICE, IMAGE READING DEVICE, AND IMAGE FORMING APPARATUS

(71) Applicant: FUJI XEROX CO., LTD., Tokyo (JP)

(72) Inventor: Keisuke UCHIYAMA, Kanagawa (JP)

(73) Assignee: FUJI XEROX CO., LTD., Tokyo (JP)

(21) Appl. No.: 15/590,253

(22) Filed: May 9, 2017

(30) Foreign Application Priority Data
Oct. 4, 2016 (JP) 2016-196583

(51) Int. Cl. H04N 1/00

(52) U.S. Cl. CPC H04N 1/00649; H04N 1/00588; H04N 2201/0081; H04N 1/00628; H04N 2201/0082; H04N 1/00625

(57) ABSTRACT

A document transport device includes a document placement table on which documents of different sizes are capable of being stacked, a feeding unit capable of moving up and down, the feeding unit being configured to send out the documents stacked on the document placement table by moving down onto the documents and to move upward after sending out the documents, an isolation unit that transports the uppermost document among the documents sent out by the feeding unit by separating the document from the other documents, and a receiving unit that receives selection of a mixed-size document mode for sending out the documents of the different sizes stacked on the document placement table. When the receiving unit receives selection of the mixed-size document mode, the isolation unit transports one of the documents while the feeding unit is maintained in a lowered state after sending out the document.

### CROSS-REFERENCE TO RELATED APPLICATIONS

This application is based on and claims priority under 35 USC 119 from Japanese Patent Application No. 2016-196583 filed Oct. 4, 2016.

### BACKGROUND

### Technical Field

The present invention relates to a document transport device, an image reading device, and an image forming apparatus.

### SUMMARY

According to an aspect of the invention, there is provided a document transport device including a document placement table on which documents of different sizes are capable of being stacked, a feeding unit that is capable of moving up and down, the feeding unit being configured to send out the documents, which are stacked on the document placement table, by moving down onto the documents and to move upward after the feeding unit has sent out the documents, an isolation unit that transports one of the documents sent out by the feeding unit, the document being at the top of the documents, by separating the document from the other documents, and a receiving unit that receives selection of a mixed-size document mode for sending out the documents of the different sizes, which are stacked on the document placement table. When the receiving unit receives selection of the mixed-size document mode, the isolation unit transports one of the documents while the feeding unit is maintained in a lowered state after the feeding unit has sent out the document.

### BRIEF DESCRIPTION OF THE DRAWINGS

An exemplary embodiment of the present invention will be described in detail based on the following figures, wherein:

FIG. 1 is a schematic sectional view illustrating the internal structure of an image forming apparatus;

FIG. 2 is a sectional view illustrating the internal structure of a reading unit;

FIG. 3 is a block diagram illustrating an example of the functional configuration of the image forming apparatus;

FIG. 4 is a schematic sectional view illustrating the configuration of an automatic document feeding unit;

FIG. 5 is a schematic plan view illustrating the configuration of the automatic document feeding unit;

FIGS. 6A to 6C are schematic sectional views each illustrating operation of the automatic document feeding unit that sends out documents of mixed sizes;

FIGS. 7A to 7C are schematic sectional views each illustrating operation of the automatic document feeding unit that sends out documents having the same size;

FIGS. 8A and 8B are flowcharts illustrating the flow of operation of the automatic document feeding unit; and

FIG. 9 is a schematic plan view illustrating skewing of a document having a small size.

### DETAILED DESCRIPTION

Although an exemplary embodiment of the present invention will now be described in detail below using a specific example and with reference to the drawings, the present invention is not limited to the following exemplary embodiment and specific example.

In the drawings that will be referred to in the following description, objects are schematically illustrated, and it should be noted that dimensional ratios and so forth of the objects that are illustrated in the drawings are different from those of actual objects. In addition, in the drawings, illustration of components that are not necessary for the following description is suitably omitted for ease of understanding.
(1) Overall Configuration and Operation of Image Forming Apparatus

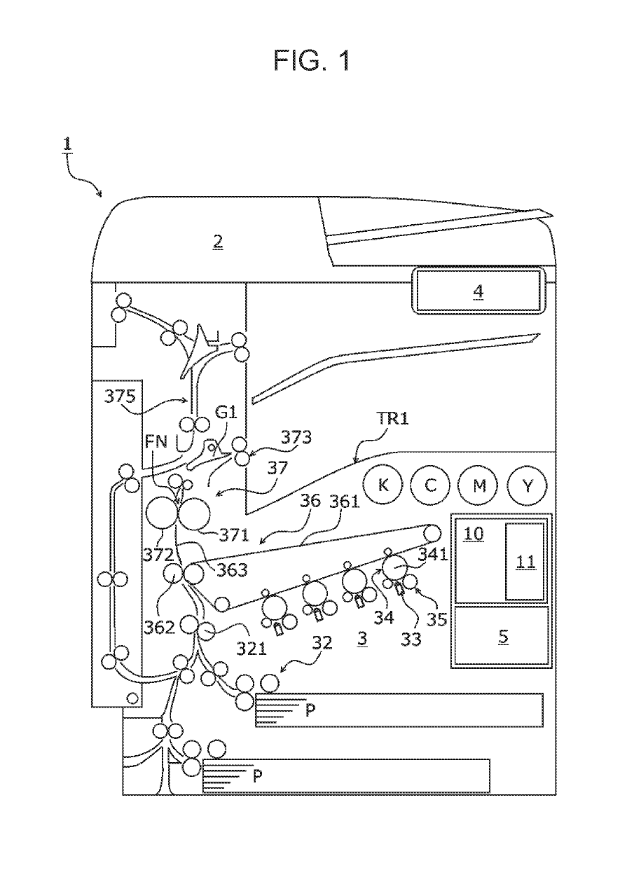

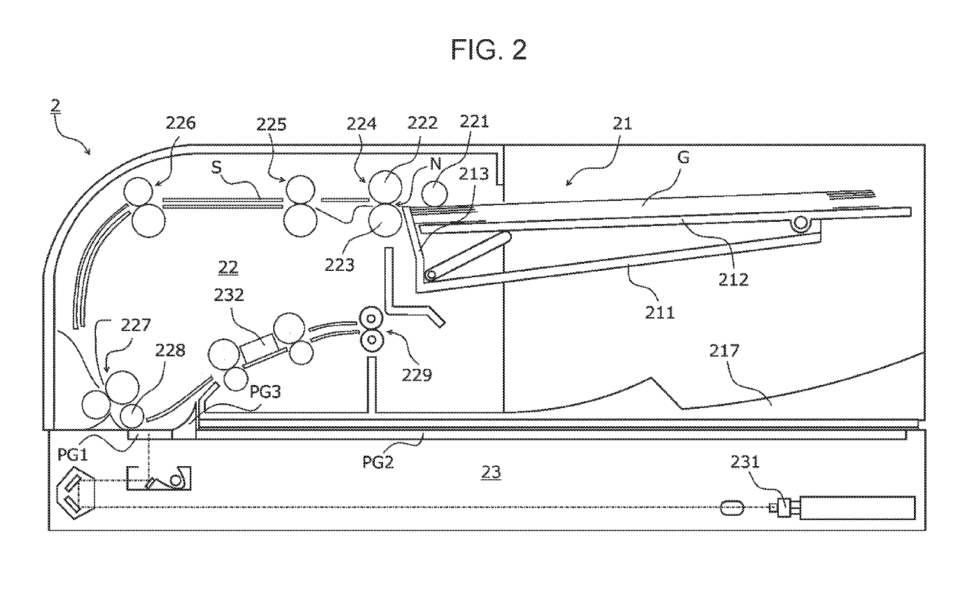

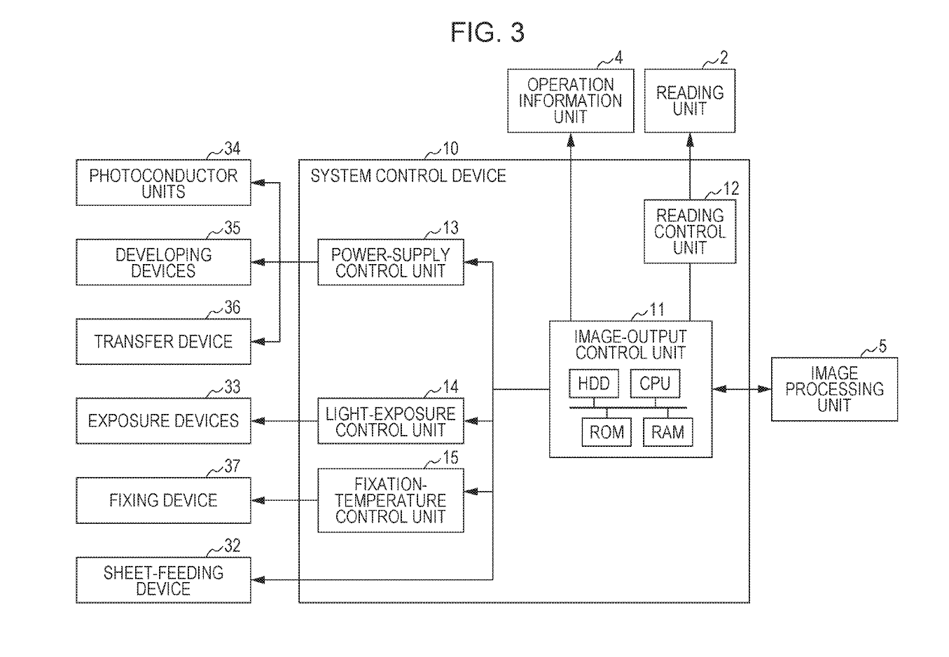

FIG. 1 is a schematic sectional view illustrating the internal structure of an image forming apparatus 1 according to an exemplary embodiment of the present invention. FIG. 2 is a sectional view illustrating the internal structure of a reading unit 2. FIG. 3 is a block diagram illustrating an example of the functional configuration of the image forming apparatus 1. The overall configuration and operation of the image forming apparatus 1 will now be described below with reference to the drawings.

### (1.1) Overall Configuration

The image forming apparatus 1 includes the reading unit 2 serving as a reading unit that reads an image from a document and converts the image into image data, an image forming unit 3 serving as a printing unit that prints image data, which has been read, onto a sheet, which is a recording medium, an operation information unit 4 serving as a user interface, and an image processing unit 5.

The reading unit 2 includes a document stacking unit 21, an automatic document feeding unit 22, and an image reading unit 23. The image reading unit 23 transports one of documents G placed on the document stacking unit 21 to a reading position in the image reading unit 23. Then, in the image reading unit 23, an image read by an image sensor (not illustrated), such as a charge-coupled device (CCD) line sensor, is converted into image data, which is an electrical signal.

The image forming unit 3 includes a sheet-feeding device 32, exposure devices 33, photoconductor units 34, developing devices 35, a transfer device 36, and a fixing device 37. The image forming unit 3 forms, by using image information received thereby from an image processing unit 5, a toner image onto one of sheets P sent from the sheet-feeding device 32.

The operation information unit 4 serving as a user interface is disposed on the front side of the reading unit 2. The operation information unit 4 is formed by combining a liquid crystal display panel, various operation buttons, a touch panel, and the like, and a user who uses the image forming apparatus 1 performs various setting and input operations by using the operation information unit 4, which is an example of a receiving unit. The liquid crystal display panel displays various information items to the user who uses the image forming apparatus 1.

The image processing unit 5 generates image data by using an image read by the reading unit 2 and print information transmitted from an external device (e.g., a personal computer).

### (1.2) Reading Unit

The reading unit 2 includes the document stacking unit 21, the automatic document feeding unit 22, and the image reading unit 23. Note that the document stacking unit 21 and the automatic document feeding unit 22 are coupled to each other in such a manner as to be capable of being opened and closed above the image reading unit 23.

The document stacking unit 21 includes a raising-and-lowering plate 212, and the documents G on which images have been recorded are to be placed on the raising-and-lowering plate 212. The raising-and-lowering plate 212 is capable of moving up and down in accordance with the number of the documents G stacked thereon and holds the documents G at a raised position at which the top surface of the documents G is in contact with a nudger roller 221.

The automatic document feeding unit 22 includes the nudger roller 221, which is an example of a feeding unit that picks up the documents G, which are stacked on the raising-and-lowering plate 212, in the order from top to bottom and an isolation unit 224, which is an example of an isolation unit that is formed of a feed roller 222 serving as a feeding roller and a retard roller 223 serving as an isolation roller that is pressed into contact with the feed roller 222.

In the isolation unit 224, the feed roller 222 and the retard roller 223 are paired with each other, and when some of the documents G are sent out to a nip part N in a state of being superposed with each other, the feed roller 222 and the retard roller 223 isolate (separate) the documents G from each other such that the documents G are transported one by one to the image reading unit 23.

In a transport path S, transport rollers 225 are disposed at positions downstream from the feed roller 222 in a transport direction of the documents G. The transport rollers 225 transport one of the documents G sent out by the feed roller 222 to pre-registration rollers 226.

Registration rollers 227 that adjust the timing of transportation of the documents G are disposed downstream from the pre-registration rollers 226. The pre-registration rollers 226 corrects skewing of one of the documents G by forming the document G into a loop in a state where an end of the document G is in contact with the registration rollers 227, which are stationary. The registration rollers 227 are driven so as to rotate in accordance with the timing at which a reading operation is started. One of the documents G is pressed against a document-passing surface PG1 by a platen roller 228 while formed in a loop by the transport rollers 225 and the pre-registration rollers 226, and the front surface of the document G is read by the image reading unit 23.

A document placement surface PG2 is disposed on the right-hand side of the document-passing surface PG1. One of the documents G placed by an operator is supported on the document placement surface PG2. A document guide PG3 is disposed between the document-passing surface PG1 and the document placement surface PG2. One of the documents G that has passed over the document-passing surface PG1 is guided by the document guide PG3 so as to be transported to a reading sensor 232. One of the documents G whose front surface has been read by the image reading unit 23 is ejected to a sheet ejection unit 217, which is formed below the document stacking unit 21, by ejection rollers 229 while the rear surface thereof is read by the reading sensor 232.

An image reading sensor 231 that optically reads an image of one of the documents G and converts the image into an electrical signal is disposed below the document placement surface PG2 and reads an image of one of the documents G that passes over the document-passing surface PG1 or an image of one of the documents G that is placed on the document placement surface PG2. The read image is converted into image data, which is an electrical signal.

### (1.3) Image Forming Unit

In the image forming unit 3, the sheets P each of which is specified to be subjected to a printing operation by a print job are sent from the sheet-feeding device 32 one by one to the image forming unit 3 in accordance with the timing of image formation.

The photoconductor units 34 are arranged side by side above the sheet-feeding device 32 (arranged in a row in the Z direction), and each of the photoconductor units 34 includes a photoconductor drum 341 that is driven so as to rotate. The developing devices 35 form toner images of yellow (Y), magenta (M), cyan (C), and black (K) on the corresponding photoconductor drums 341, on which electrostatic latent images have been formed by the corresponding exposure devices 33.

The toner images of the different colors formed on the photoconductor drums 341 of the photoconductor units 34 are sequentially and electrostatically transferred (transferred in a first transfer process) onto an intermediate transfer belt 361 of the transfer device 36, and as a result, a superposed toner image is formed of the toner images of the different colors superposed with one another. The superposed toner image on the intermediate transfer belt 361 is transferred, by a second transfer roller 362, onto one of the sheets P that is sent out by a pair of registration rollers 321 and guided by a transport guide.

In the fixing device 37, a fixing nip FN (fixing region) is formed of a region in which a heating module 371 and a pressing module 372 that are paired with each other are pressed into contact with each other.

The sheet P to which the toner images have been collectively transferred in the transfer device 36 is transported to the fixing nip FN of the fixing device 37 through a transport guide 363 in a state where the toner images are unfixed to the sheet P, and the toner images are fixed onto the sheet P as a result of pressure and heat being applied thereto by the heating module 371 and the pressing module 372, which are paired with each other.

The sheet P to which the toner images have been fixed is guided to a switching gate G1 and ejected by a first pair of ejection rollers 373 to a sheet-ejection tray unit TR1, which is formed on the top surface of the image forming apparatus 1, and accommodated in the sheet-ejection tray unit TR1. In the case of flipping over one of the sheets P for performing two-sided printing and in the case of ejecting one of the sheets P in a state where a surface thereof on which an image has been recorded faces upward, the transport direction of the sheet P is switched toward a transport path 375 by the switching gate G1.

### (1.3 Block Configuration of Image Forming Apparatus)

The image forming apparatus 1 includes a system control device 10 including an image-output control unit 11, a reading control unit 12, a power-supply control unit 13, a light-exposure control unit 14, and a fixation-temperature control unit 15. The overall operation of the image forming apparatus 1 is controlled as a result of control programs stored in a memory being run.

The image-output control unit 11 issues operation-control instructions to the sheet-feeding device 32, the exposure devices 33, the photoconductor units 34, the developing devices 35, the transfer device 36, the fixing device 37, and the like, which are included in the image forming unit 3.

In addition, the image-output control unit 11 issues operation-control instructions to the power-supply control unit 13, the light-exposure control unit 14, the fixation-temperature control unit 15, which are included in the system control device 10. In other words, the image-output control unit 11 determines whether to supply power to and whether to drive the sheet-feeding device 32, the exposure devices 33, the photoconductor units 34, the developing devices 35, the transfer device 36, the fixing device 37, and the like, which are included in the image forming unit 3, and informs the control units of the determination results.

Transmission and reception of information is performed between the image-output control unit 11 and the reading control unit 12, and when the image-output control unit 11 receives an instruction to start image reading via the operation information unit 4, the image-output control unit 11 performs a predetermined image-reading control.

The reading control unit 12 controls the operation of the reading unit 2 in such a manner that an image of one of the documents G stacked on the document stacking unit 21 is read by being scanned while the document G is transported to the image reading unit 23 through the automatic document feeding unit 22, and the reading control unit 12 receives the read image data. The received image data is stored in a memory (HDD).

### (2) Configuration and Operation of Automatic Document Feeding Unit

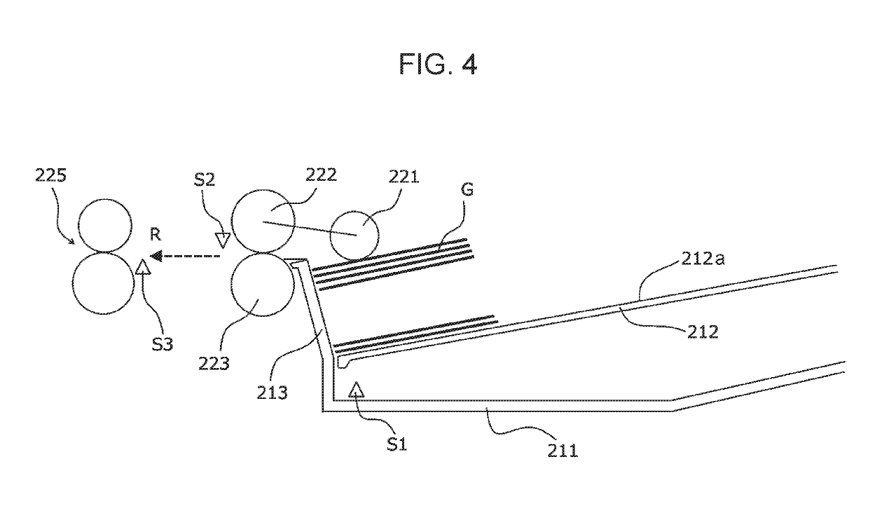

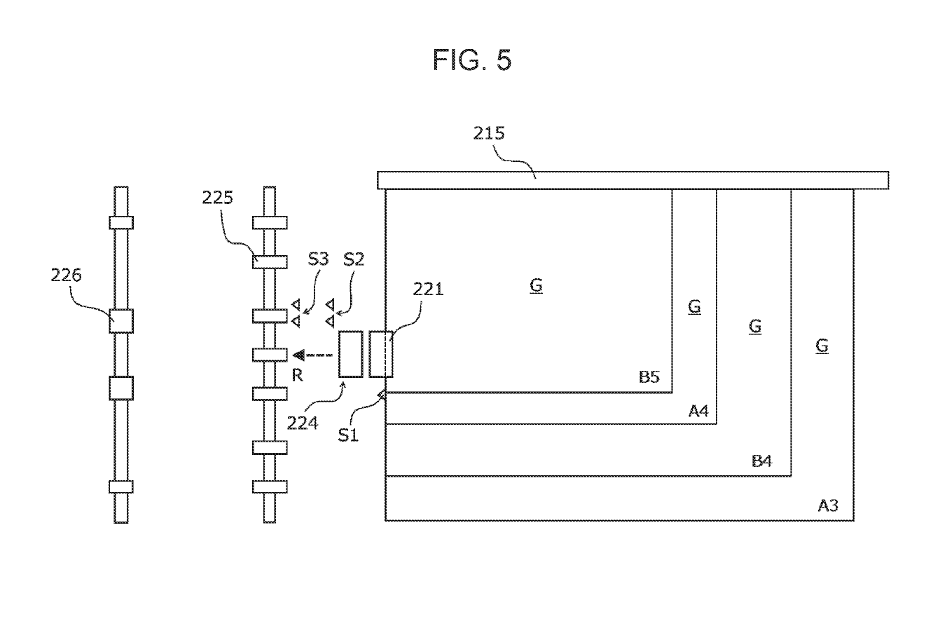

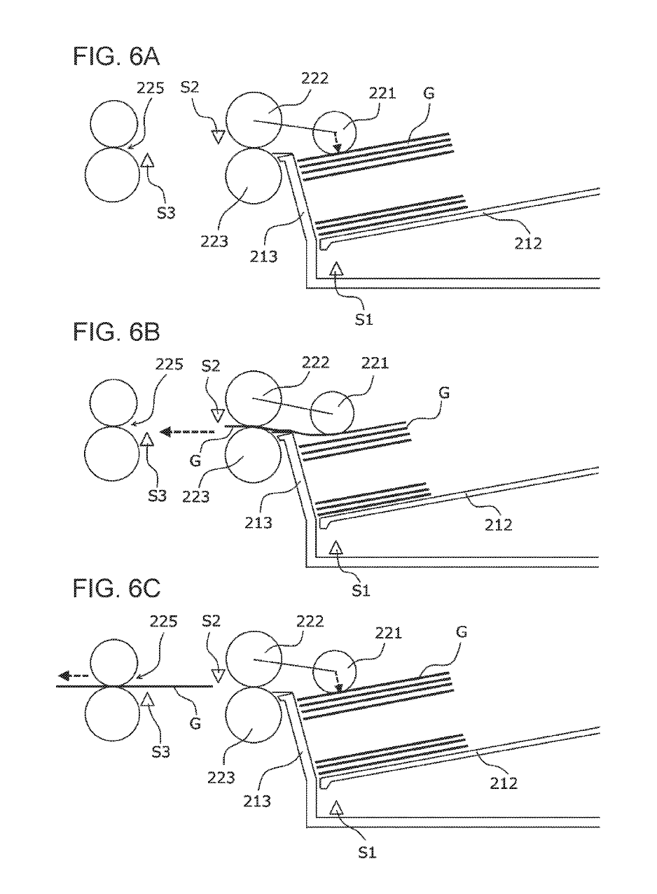

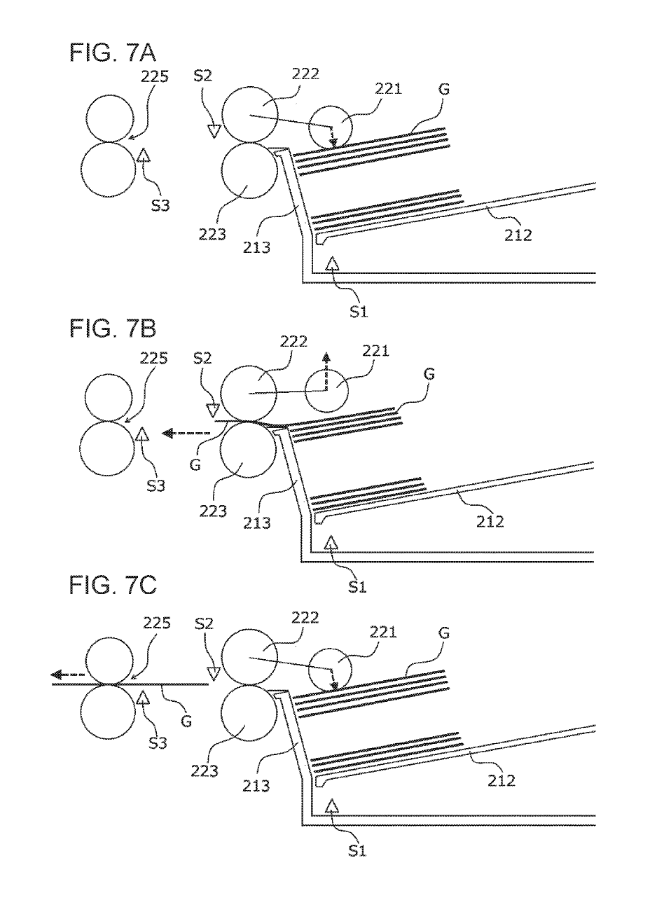

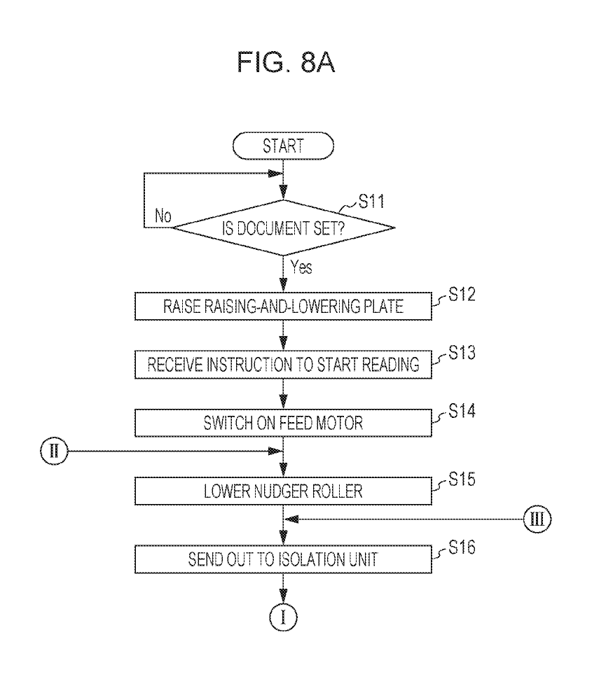

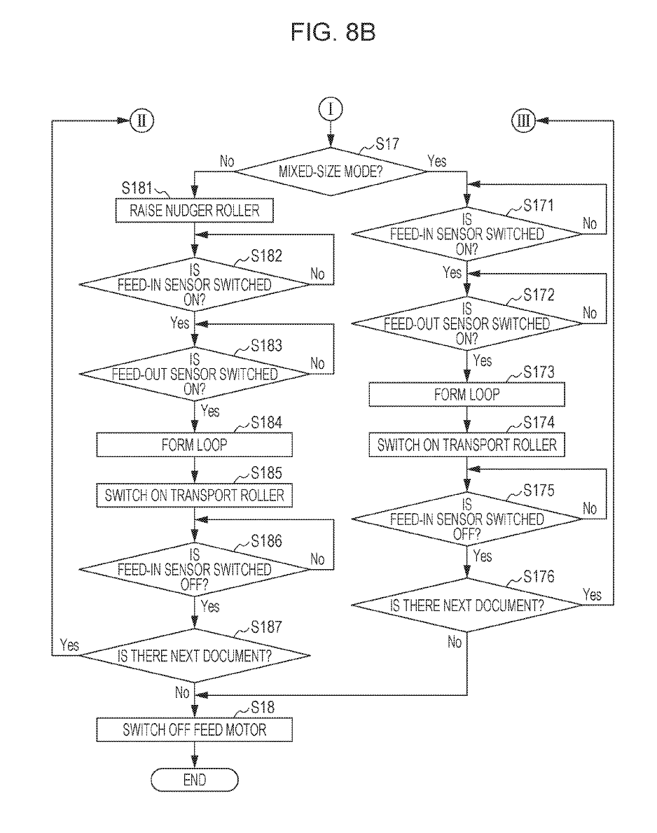

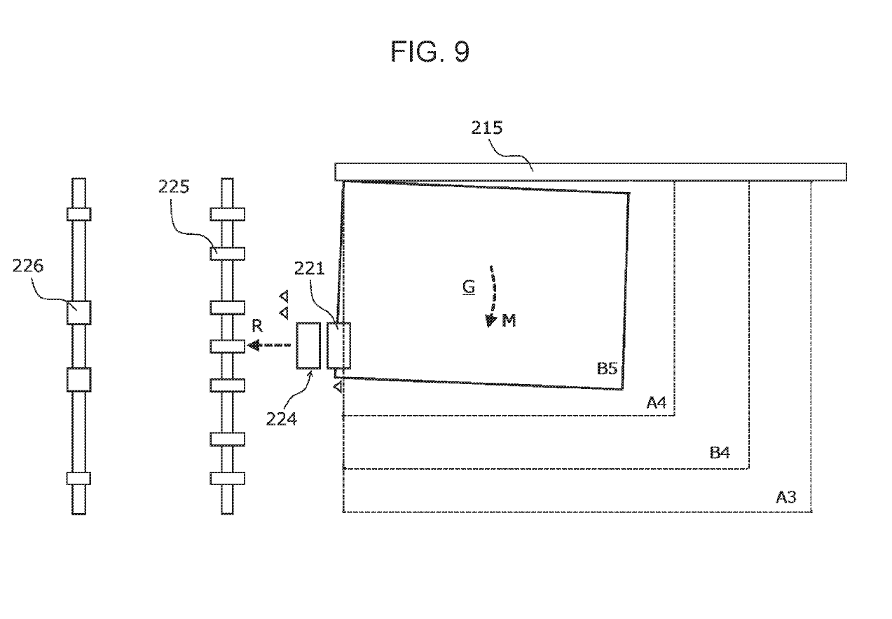

FIG. 4 is a schematic sectional view illustrating the configuration of the automatic document feeding unit 22. FIG. 5 is a schematic plan view illustrating the configuration of the automatic document feeding unit 22. FIGS. 6A to 6C are schematic sectional views each illustrating operation of the automatic document feeding unit 22 that sends out the documents G of mixed sizes, FIG. 6A illustrating a state where the nudger roller 221 has been lowered, FIG. 6B illustrating a state where one of the documents G is transported in the isolation unit 224 while the nudger roller 221 has been lowered, and FIG. 6C illustrating a state where the nudger roller 221 has been lowered for sending out the next document G. FIGS. 7A to 7C are schematic sectional views each illustrating operation of the automatic document feeding unit 22 that sends out the documents G having the same size, FIG. 7A illustrating a state where the nudger roller 221 has been lowered, FIG. 7B illustrating a state where the nudger roller 221 has been raised, and FIG. 7C illustrating a state where the nudger roller 221 has been lowered for sending out the next document G. FIGS. 8A and 8B are flowcharts illustrating the flow of operation of the automatic document feeding unit 22. FIG. 9 is a schematic plan view illustrating skewing of one of the documents G that has a small size. The configurations and operations of the document stacking unit 21 and the automatic document feeding unit 22 including the isolation unit 224 will be described below with reference to the drawings.

### (2.1) Overall Configuration of Automatic Document Feeding Unit

The automatic document feeding unit 22 includes the isolation unit 224, which separates one by one the documents G sent out from the document stacking unit 21 by the nudger roller 221 and sends out the documents G to the image reading unit 23, and the transport rollers 225, which transport one of the documents G separated from the other documents G by the isolation unit 224 to the pre-registration rollers 226.

In the document stacking unit 21, the raising-and-lowering plate 212 is supported on a tray body 211 in such a manner as to be capable of moving up and down, and the documents G of different sizes, that is, the documents G at least one of whose document lengths, which are the lengths of the documents G in a document transport direction (indicated by arrow R in FIG. 4 and FIG. 5), and document widths, which are the lengths of the documents G in a direction crossing (perpendicular to) the document transport direction, are different from one another are capable of being stacked on the raising-and-lowering plate 212.

The tray body 211 includes a document-end-aligning portion 213 formed on the side to which the documents G are to be sent out. One end of each of the documents G, which are stacked on the top surface 212a of the raising-and-lowering plate 212, the one end being the leading end in the document transport direction, is brought into contact with the document-end-aligning portion 213 such that the leading ends of the documents G are aligned.

A side guide 215 is disposed so as to be fixed in place on one end side in the direction crossing (perpendicular to) the document transport direction, the one end side being the far side of the reading unit 2, and a side-registration method is employed. In the side-registration method, the documents G of different sizes are aligned in a document width direction as a result of one side of each of the documents G in the width direction being aligned with respect to a reference that is the side guide 215.

The nudger roller 221 is disposed above the document-end-aligning portion 213 so as to be close to the feed roller 222. The nudger roller 221 is lifted up so as to be held at a retreat position while being in a standby state. When one of the documents G is sent out, the nudger roller 221 is lowered to a nip position (document feeding position) and sends out one of the documents G on the raising-and-lowering plate 212, the document G being at the top of the documents G.

Raising and lowering of the nudger roller 221 is controlled by starting and stopping rotation of a feed motor MR (not illustrated) by using a solenoid (not illustrated).

The isolation unit 224 is disposed downstream from the document-end-aligning portion 213 in the document transport direction. The isolation unit 224 is formed of the feed roller 222 and the retard roller 223 that forms a nip part N by being pressed into contact with the feed roller 222. The feed roller 222 rotates in the same direction as that in which the nudger roller 221 rotates and transports one of the documents G sent out by the nudger roller 221 further toward the downstream side in the document transport direction.

A driving force is transmitted to the retard roller 223 via a torque limiter (not illustrated) in such a manner that the retard roller 223 rotates in a direction opposite to the document transport direction. The feed roller 222, which is pressed into contact with the retard roller 223, rotates in the document transport direction such that a torque in the document transport direction is applied to the retard roller 223. A set torque of the torque limiter is set to be smaller than the torque applied to the retard roller 223 by the feed roller 222, and thus, the retard roller 223 is driven and rotates in the document transport direction as a result of rotation of the feed roller 222.

In the case where two or more of the documents G are sent to the nip part N in the isolation unit 224 (in the case of double feeding), since the friction coefficient between the documents G is smaller than the friction coefficient between the feed roller 222, the retard roller 223, and the documents G, the retard roller 223, which receives a driving force in the direction opposite to the document transport direction via the torque limiter, rotates in the direction opposite to the document transport direction. As a result, the documents G excluding the uppermost document G are caused to return to the document stacking unit 21 such that the uppermost document G is isolated and separated from the other documents G.

The transport rollers 225 are disposed downstream from the isolation unit 224 in the document transport direction. Rotation of each of the transport rollers 225 is controlled by a clutch (not illustrated). The transport rollers 225 form one of the documents G sent out by the feed roller 222 into a loop by temporarily stopping the document G and then transport the document G to the pre-registration rollers 226 while correcting skewing of the document G.

In the automatic document feeding unit 22, which has the above-described configuration, a document sensor S1 is disposed below the raising-and-lowering plate 212 as illustrated in FIG. 4 and FIG. 5. The document sensor S1 is formed of a light-reflective sensor and is disposed at a position where the document sensor S1 is capable of detecting the minimum document size in the document width direction so as to detect the presence or absence of the documents G stacked on the document stacking unit 21.

Two feed-in sensors S2 are disposed downstream from the nip part N in the isolation unit 224. The feed-in sensors S2 are formed of light-reflective sensors and determine, by detecting the leading end of one of the documents G, which has been separated from the other documents G by the isolation unit 224, whether a situation in which the isolation unit 224 has failed to feed one of the documents G (misfeeding in the isolation unit 224) has occurred. The feed-in sensors S2 are arranged at positions spaced apart from each other in the document width direction in such a manner as to detect skewing of one of the documents G, which is sent out by the isolation unit 224, by using the difference in detection timing between the feed-in sensors S2.

Feed-out sensors S3 are disposed upstream from the transport rollers 225. The feed-out sensors S3 are formed of light-reflective sensors and each detect the leading end of one of the documents G transported from the isolation unit 224 so as to act as a trigger for bringing the document G into contact with the transport rollers 225, which are stationary, and forming the document G into a loop. A feed amount corresponding to a predetermined number of pulses is set after the feed-out sensors S3 have been switched on, and the document G is formed into a loop.

### (2.2) Mixed-Size-Document Transportation Mode

The reading unit 2 according to the exemplary embodiment has a mixed-size document mode in which transportation of the documents G of different sizes is allowed and a normal mode in which transportation of the documents G of different sizes is not allowed. In the normal mode, transportation of only the documents G having the same size is allowed.

According to the exemplary embodiment, in the mixed-size document mode, the documents G of different sizes are brought together and stacked on the raising-and-lowering plate 212. The documents G of different sizes are sequentially transported, and images of the documents G are read.

The mixed-size document mode is set as a result of a user selecting the mixed-size document mode by using the operation information unit 4. Once the mixed-size document mode has been selected, processing for the mixed-size document mode is performed.

In the mixed-size document mode, in a state where the documents G of different sizes are aligned in the document width direction while the side guide 215 functions as a reference, the documents G are sequentially sent out starting from the uppermost document G, on which the nudger roller 221 has been placed.

As illustrated in FIG. 9, for example, when a B5 document G, which has a small size, among the documents G of different sizes is sent out, since the B5 document G is transported while one end portion thereof in the width direction is nipped, there is a possibility that the document G will be skewed as a result of a rotation moment M about the side guide 215 acting on the document G.

In the automatic document feeding unit 22 according to the exemplary embodiment, in the case of the mixed-size document mode, in which transportation of the documents G of different sizes is allowed, the nudger roller 221 serving as a feeding unit is maintained in a lowered state after sending out one of the documents G, and the isolation unit 224 transports the document G to the transport rollers 225 while a portion of the document G on the upstream side is pressed by the nudger roller 221.

When reading images of the documents G of different sizes, a user who uses the image forming apparatus 1 places the documents G such that the documents G are aligned by the side guide 215 located on the far side and the document-end-aligning portion 213 located on the distal side in the document transport direction.

When the documents G are placed on the raising-and-lowering plate 212 of the document stacking unit 21, and the document sensor S1 is switched on (S11: Yes), the reading control unit 12 raises the raising-and-lowering plate 212 in such a manner that the documents G are capable of being sent out (S12).

In this state, when a reading start key is pressed via the operation information unit 4 (S13), the feed motor MR (not illustrated) is driven (S14), and the nudger roller 221 is lowered toward the top surface of the documents G (S15: see FIG. 6A).

In the state where the nudger roller 221 has been lowered, the nudger roller 221, the feed roller 222, and the retard roller 223 are driven so as to rotate, and one of the documents G is sent out to the isolation unit 224 (S16). Then, the reading control unit 12 determines whether the mixed-size document mode has been selected via the operation information unit 4 (S17). In the case where the mixed-size document mode has been selected (S17: Yes), the nudger roller 221 is maintained in a lowered state (see FIG. 6B).

Subsequently, it is determined whether a situation in which the isolation unit 224 has failed to feed the document G (misfeeding in the isolation unit 224) has occurred (S171). In other words, when the document G is sent after being separated from the other documents G by the isolation unit 224, the feed-in sensors S2 are switched on (S171: Yes). In the case where the situation in which the isolation unit 224 has failed to feed the document G (misfeeding in the isolation unit 224) has not occurred, it is determined whether the leading end of the document G has reached the feed-out sensors S3 (S172).

When the feed-out sensors S3 are switched on (S172: Yes), the document G is transported while the transport rollers 225 are stationary, and the document G is formed into a predetermined loop (S173). This loop is formed by counting drive pulses applied to the feed motor MR by using the timing at which the feed-out sensors S3 are switched on as a trigger.

Then, the transport rollers 225 is driven so as to rotate (S174), and when the feed-out sensors S3 are switched off after the trailing end of the document G has passed through the feed-out sensors S3 (S175: Yes), it is determined whether there is still another document G in the document stacking unit 21 (S176). In the case where there is still another document G (S176: Yes), the above-described document feeding operation is repeated (see FIG. 6C) unless the document sensor S1 is switched off (S176: No).

### (2.3) Same-Size-Document Transportation Mode

In the case where a same-size-document transportation mode is selected in step S17 (S17: No), the nudger roller 221 is raised (S181), and it is determined whether a situation in which the isolation unit 224 has failed to feed one of the documents G (misfeeding in the isolation unit 224) has occurred (S182).

In the case where the situation in which the isolation unit 224 has failed to feed the document G (misfeeding in the isolation unit 224) has not occurred, it is further determined whether the leading end of the document G has reached the feed-out sensors S3 (S183). When the feed-out sensors S3 are switched on (S183: Yes), the document G is transported while the transport rollers 225 are stationary, and the document G is formed into a predetermined loop (S184).

Then, the transport rollers 225 are driven so as to rotate (S185), and when the feed-out sensors S3 are switched off after the trailing end of the document G has passed through the feed-out sensors S3 (S186: Yes), it is determined whether there is still another document G in the document stacking unit 21 (S187). In the case where there is still another document G (S187: Yes), the above-described document feeding operation is repeated unless the document sensor S1 is switched off (S187: No). In the case where the document sensor S1 is switched off (S187: No), driving of the feed motor MR is discontinued (S18), and the document transport operation is exited.

In the automatic document feeding unit 22 according to the exemplary embodiment, in the mixed-size document mode in which the documents G of different sizes are stacked on the raising-and-lowering plate 212, the nudger roller 221 is maintained in a lowered state after sending out one of the documents G, and the isolation unit 224 transports the document G to the transport rollers 225 while a portion of the document G on the upstream side is pressed by the nudger roller 221.

As a result, the document G is sent out in a state where the top surface of the document G is pressed by the nudger roller 221 at a position spaced apart from the isolation unit 224 on the upstream side in the document transport direction.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A document transport device comprising:
a document placement table on which documents of different sizes are capable of being stacked;
a feeding unit that is capable of moving up and down, the feeding unit being configured to send out the documents, which are stacked on the document placement table, by moving down onto the documents and to move upward after the feeding unit has sent out the documents;
an isolation unit that transports one of the documents sent out by the feeding unit, the document being at the top of the documents, by separating the document from the other documents; and
a receiving unit that receives selection of a mixed-size document mode for sending out the documents of the different sizes, which are stacked on the document placement table,
wherein, when the receiving unit receives selection of the mixed-size document mode, the isolation unit transports one of the documents while the feeding unit is maintained in a lowered state after the feeding unit has sent out the document.

2. The document transport device according to claim 1,
wherein the documents of the different sizes are stacked such that one side of each of the documents is brought into contact with one end of the document placement table in a direction crossing a direction in which the documents are sent out.

3. An image reading device comprising:
an imaging member that reads an image of a document; and
the document transport device according to claim 1 that transports the document to a reading position at which the imaging member reads the document.

4. An image reading device comprising:
an imaging member that reads an image of a document; and
the document transport device according to claim 2 that transports the document to a reading position at which the imaging member reads the document.

5. An image forming apparatus comprising:
the image reading device according to claim 3 that reads an image of a document; and
an image recording device that records an image read by the image reading device onto a recording medium.

6. An image forming apparatus comprising:
the image reading device according to claim 4 that reads an image of a document; and
an image recording device that records an image read by the image reading device onto a recording medium.
